(19) United States
(12) Patent Application Publication
(10) Pub. No.: US 2015/0070898 A1
(43) Pub. Date: Mar. 12, 2015

(54) Automatic On/Off Lighting and Method

(71) Applicant: Brian Magnaye, Hillsboro, OR (US)

(72) Inventor: Brian Magnaye, Hillsboro, OR (US)

(21) Appl. No.: 14/480,563

(22) Filed: Sep. 8, 2014

Related U.S. Application Data
(60) Provisional application No. 61/874,547, filed on Sep. 6, 2013.

(51) Int. Cl. F21V 23/04; F21V 23/00; F21V 23/06; F21K 99/00

(52) U.S. Cl. CPC F21V 23/0464; F21K 9/1355; F21V 23/0407; F21V 23/003; F21V 23/06; F21W 2121/04
USPC 362/276

(57) ABSTRACT

A device for turning off one or more lights using a light sensitive component in an electrical circuit and method thereof. There is a portable, low power, and self-contained electric light device which easily installs into a conventional 120 volt socket and automatically turns off when light is detected by the device. The device comprises: an electrical circuit including a light sensitive component and one or more lights, a metal stem for coupling with a conventional electrical threaded socket, a case, and a cover. A method for turning off one or more lights is also provided comprising: providing a light sensitive component and one or more lights in an electrical circuit, connecting the electrical circuit to a metal stem, housing the electrical circuit in a case and installing the light sensitive component in the case, and engaging the metal stem into a conventional socket for electrical energy.

### CROSS-REFERENCE TO RELATED APPLICATION

This application claims priority to U.S. provisional patent application Ser. No. 61/874,547, filed on Sep. 6, 2013, which is hereby incorporated by reference in its entirety.

### BACKGROUND

1. Held of Invention

Aspects of the present invention relate to a device for and method of turning off one or more lights. In particular, there is a device for turning off one or more lights using a light sensitive component in an electrical circuit, and a method thereof.

2. Background

Decorative lights such as special occasion, holiday, or Christmas lights are well-known and widely used. An example of a Christmas light is a string of lights which plugs into a power outlet. In many cases, the string has a combination of multi-colored lights that flash repeatedly. However, one disadvantage is that flashing, decorative lights do not couple with conventional electrical threaded sockets. Unlike a light bulb, a flashing, decorative light such as a Christmas light plugs into a power outlet.

Another disadvantage is that decorative lights are not portable. A user will spend time running a string of Christmas lights around a house and running the lights around permanent obstacles, having to go up and down a ladder each time more lights are secured. In many cases, a user will not remove the Christmas lights and will leave the lights secured on the house during the entire year.

Decorative lights as well as standard exterior home lights, also do not automatically turn on during the night and automatically turn off during the day. A user may not turn on the lights until well into the night when they remember or when they arrive back at the house. Further, a user may not remember to turn off the lights.

### SUMMARY

Accordingly, there is a need for an electric light device that eliminates the aforementioned disadvantages. To address this need, there is provided an electric light device that couples with a conventional electrical threaded socket, is portable, easily installed, cost effective, and automatically turns off when light is detected by the device.

In one aspect of the present invention, there is provided an electrical circuit in the device configured for connecting one or more lights to a metal stem that couples with a conventional electrical threaded socket and has low power consumption. Accordingly, no replacement of the existing electrical socket is required.

In another aspect of the present invention, the one or more lights are contained in a cover coupled with a case, where the case is connected to the metal stem. The device is self-contained, portable, and easy to install, whether installation is indoor, outdoor, commercial, or for private use.

In another aspect of the present invention, the electrical circuit includes a light sensitive component which turns the one or more lights off when light is detected by the light sensitive component.

According to an embodiment of the present invention, there is an electric light device comprising: an electrical circuit including a light sensitive component and one or more lights; a metal stem for coupling with a conventional electrical threaded socket, the metal stem connecting to the electrical circuit; a case housing the electrical circuit, and the light sensitive component residing on the case; wherein the one or more lights are off when light is detected by the light sensitive component. In an embodiment, there is also a cover, the cover being releasably attachable to the case.

In another embodiment of the present invention there is an electric light device comprising: an electrical circuit including a light sensitive component and one or more lights, the one or more lights being attached to one or more surfaces; a metal stem for coupling with a conventional electrical threaded socket, the metal stem connecting to the electrical circuit; a case having one or more slots, the case housing the electrical circuit, the light sensitive component residing on the case, and the one or more surfaces connected to the case at the one or more slots; and a cover, the cover being releasably attachable to the case; wherein the one or more lights are off when light is detected by the light sensitive component.

In another embodiment of the present invention there is a method for turning off one or more lights comprising: providing a light sensitive component and one or more lights in an electrical circuit, the one or more lights turning off when light is detected by the light sensitive component; connecting the electrical circuit to a metal stem for coupling with a conventional electrical threaded socket; housing the electrical circuit in a case and residing the light sensitive component on the case, where the case is releasably attached to a cover; and screwing the metal stem into a conventional socket for electrical energy.

According to another embodiment, the lighting device comprise: an electrical circuit including a light sensitive component, the electrical circuit operable to connect to an existing conventional light bulb; a metal stem for coupling with a conventional electrical threaded socket, the metal stem connecting to the electrical circuit; and a case housing the electrical circuit, the light sensitive component residing on the case, and the case configured to operably receive the light bulb; wherein when light is detected by the light sensitive component, electricity to the light bulb switches off. Accordingly, the device may be used with existing electrical sockets and interchangeably used with existing conventional light bulbs to create a flashing effect as well as have an automatic on/off switching ability based on light detected.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1A is an exploded view of an electric light device, according to an embodiment of the present invention.

FIG. 1B is a view of the cover, according to an alternative embodiment of the present invention.

FIG. 2A is an exploded view of an electric light device, according to an alternative embodiment of the present invention.

FIG. 2B is an assembled view of an electric light device, according to an alternative embodiment of the present invention.

FIG. 3A is a view of an electric light device, according to an alternative embodiment of the present invention.

FIG. 3B is a view of the electric light device of FIG. 3A engaged with a conventional standard light bulb, according to an embodiment of the present invention.

FIG. 4 is a schematic diagram showing an electrical circuit, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

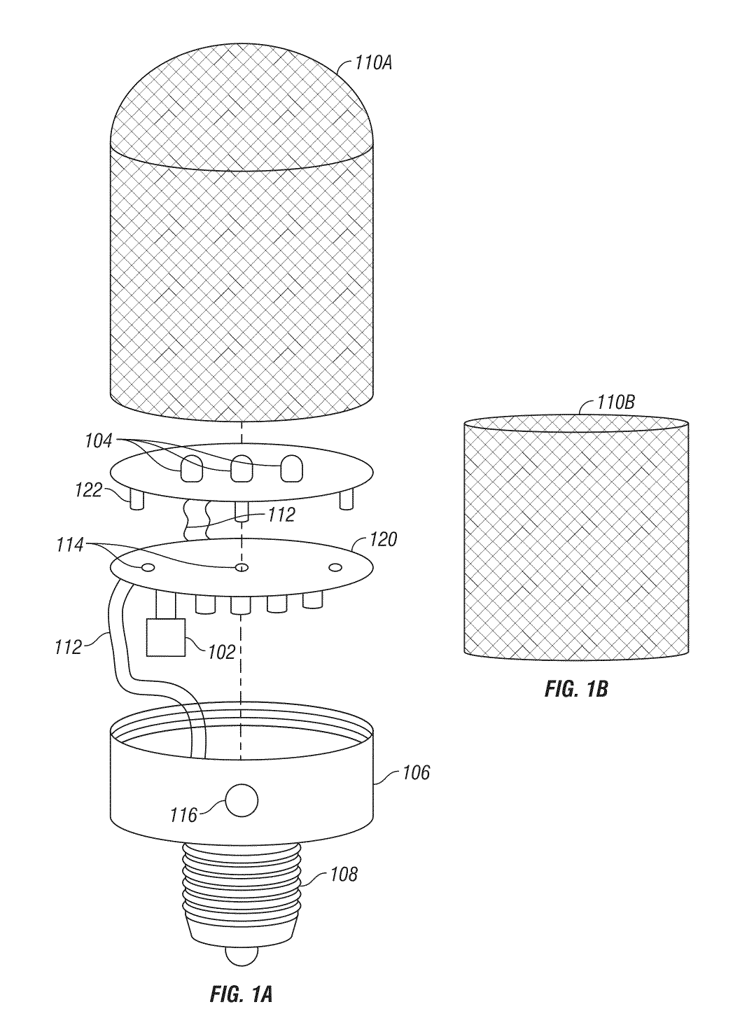

FIG. 1A illustrates one embodiment of an electric light device, in an exploded view. The electric light device comprises a case 106, a cover 110A, one or more lights 104, an electrical circuit 102, and a metal stem 108 for coupling with a conventional electrical threaded socket. The electrical circuit 102 is on one or more circuit boards 120 housed in the case 106. The electrical circuit 102 is connected to the one or more lights 104. The one or more lights 104 are preferably light emitting diodes (LEDs), but can be other alternatives by modifying components of the electrical circuit 102. The one or more lights 104 may be multicolored. Clips 122 and holes 114 secure the one or more circuit boards 120. The case 106 is connected to the metal stem 108, whereby the electric light device may screw into a conventional 120 volt socket for electrical energy. One or more wires 112 connect the one or more lights 104, the electrical circuit 102, and the metal stem 108. In a preferred embodiment, the electrical circuit 102 includes a light sensitive component 116 such as a light dependent resistor (LDR), where the light sensitive component 116 resides on the case 106. The light sensitive component 116 may reside in an opening on the case. The light sensitive component 116 may be a standard or miniature LDR housed within a sealed epoxy case with a clear lens window; and may be installed to protrude from the opening, sit flush with the outer surface of the case or be recessed within the case 106. The cover 110A is releasably attachable to the case 106 and may curve outwardly at an end opposite to the case 106, for example as a rounded dome-shape. The cover 110A and case 106 may be threaded for coupling.

According to one or more embodiments, the cover 110A is made of a plastic reflective material, enhancing and increasing distribution of light emitting from the electric light device.

Referring to FIG. 1B, the cover 110B may be substantially flat at the end opposite to the case 106.

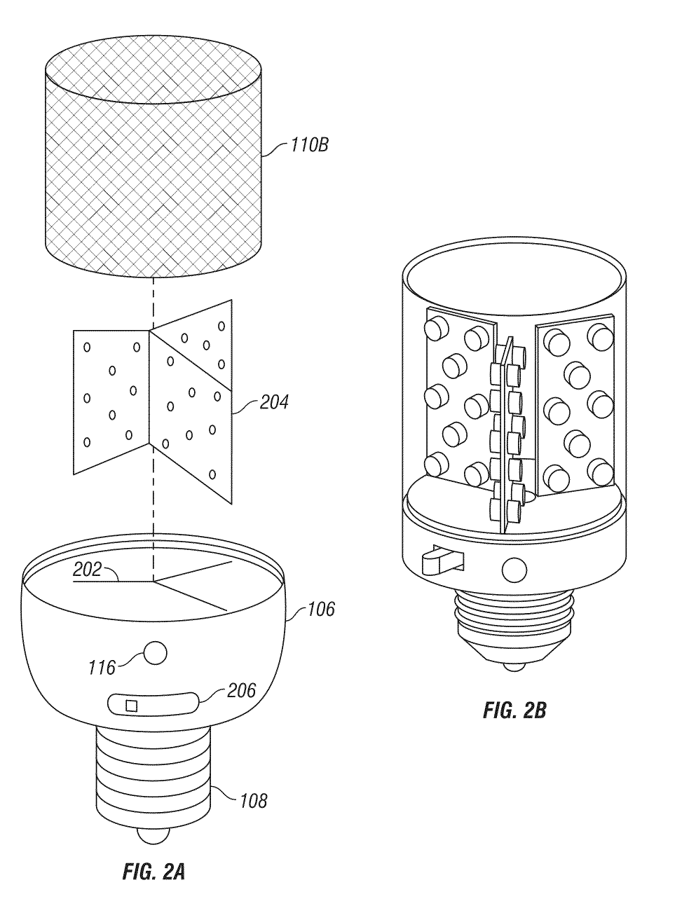

In another embodiment, as shown in FIG. 2A in an exploded view, the one or more lights 104 are attached to one or more surfaces 204, where the one or more surfaces 204 connect to the case 106 at one or more slots 202 in the case 106. The electrical circuit 102 is connected to an on/off switch 206, the on/off switch 206 being on the case. The one or more lights 104 are off when the on/off switch 206 is set to an off position and the one or more lights 104 are on when the on/off switch 206 is set to an on position, independent of the amount of light detected by the light sensitive component 116. The electrical circuit 102 may be connected to a music player, the music player producing music when the on/off switch 206 is set to an on position.

FIG. 2B shows an embodiment of the electric light device in an assembled view, where the one or more surfaces 204 are connected to the case 106 at the one or more slots 202 in the case 106 and the cover 110B is attached to the case 106.

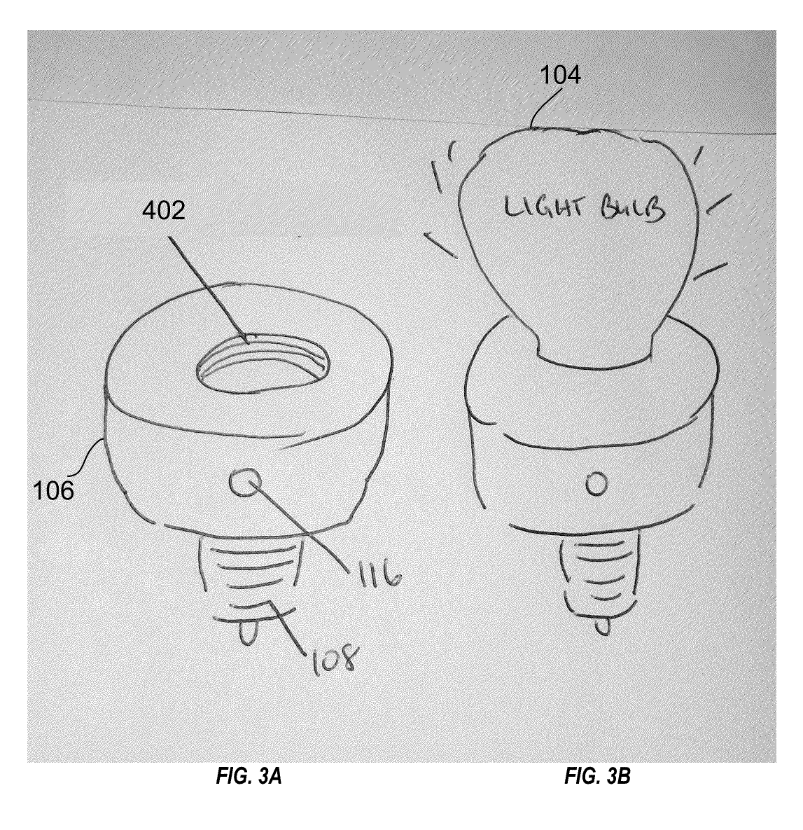

In another embodiment, as shown in FIG. 3A and FIG. 3B, the device comprises a case 106 configured for receiving at least one standard light bulb 104, where the case houses all electrical circuit components including the LDR components 116 and a metal stem 108 for engaging a conventional electrical socket. The light bulb 104 connects to the electrical circuit 102 at one or more threaded sockets 402. In this embodiment, the light 104 comprises a standard type light bulb and the electrical circuit 102 including the LDR component inside the case 106, are configured to be operable with the standard light bulb when the bulb stem is engaged with the threaded socket 402 of the device. Accordingly, conventional standard light bulbs, including incandescent, LED, CFL or halogen bulbs, can be used with the device in order to have a flashing feature or to automatically turn on or off. Such a device is convenient for exterior lighting, such as exterior home lighting, for example a porch light. The device therefore provides for flexibility as existing bulbs and the existing electrical socket can be used, which makes installation very easy and is overall cost effective.

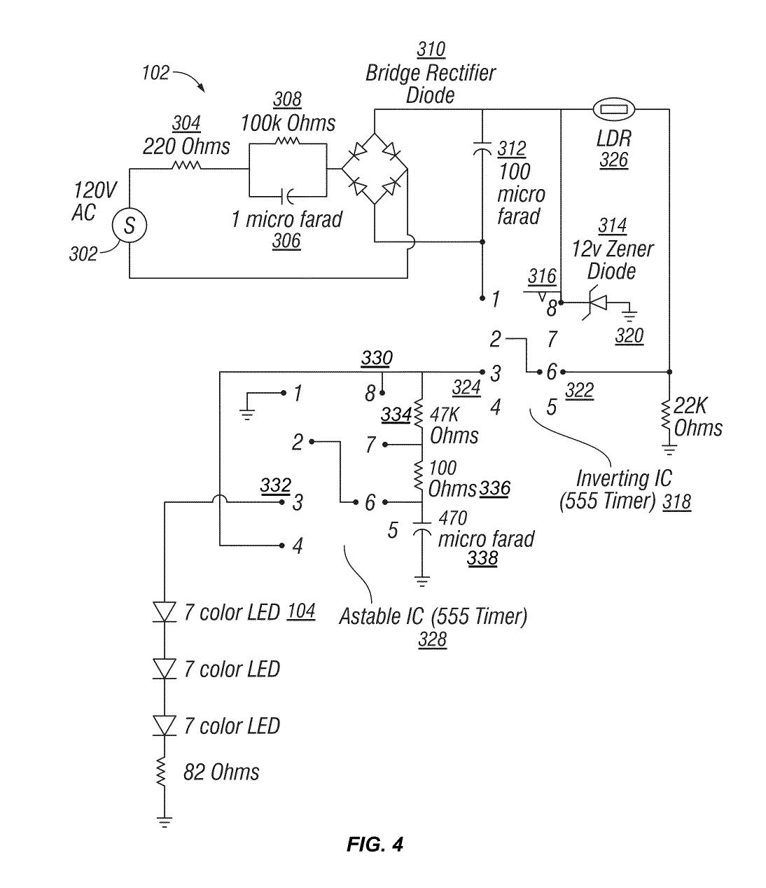

FIG. 4 shows an embodiment of the electrical circuit 102. The electrical circuit 102 is electrically connected across an alternating current (AC) input 302. In a preferred embodiment, the AC input 302 supplies 120 volts AC to the electrical circuit 102. A 220 ohm resistor 304 is provided in series to the AC input 302. The resistor 304 is connected to a bridge rectifier 310, comprising of four IN4001 rectifier diodes. The bridge rectifier 310 serves to convert AC voltage to direct current (DC) voltage. To block any DC voltage from the bridge rectifier 310 and absorb any high current or step pulses, a one microfarad capacitor 306 and a 100,000 ohm resistor 308 are provided in parallel between the resistor 304 and the bridge rectifier 310.

The bridge rectifier 310 is connected to a 100 microfarad capacitor 312, which serves to smooth DC voltage output from the bridge rectifier 310.

The capacitor 312 is connected to a 555 timer 318. The 555 timer 318 serves as an inverting buffer, having a supply voltage of 12 volt DC.

A 12 volt zener diode (type IN4742A) 314 is connected at the cathode to the 555 timer 318 at pin 8 316 and connected at the anode to ground 320, which controls voltage going to the 555 timer 318 and prevents voltage going to the 555 timer 318 from exceeding 12 volts.

When voltage going to the 555 timer 318 at pin 6 322 is less than ⅓ of the supply voltage of 12 volts, the output voltage of the 555 timer 318 at pin 3 324 will be high. When voltage going to the 555 timer 318 at pin 6 322 is greater than ⅔ of the supply voltage of 12 volts, the output voltage of the 555 timer 318 at pin 3 324 will be low.

A light dependent resistor (LDR) 326 is connected between the 555 time 318 at pin 8 316 and the 555 timer 318 at pin 6 322, which controls voltage going to the 555 timer 318 at pin 6 322. The LDR 326 changes resistance based on the amount of light detected by the LDR 326. LDR resistance is low when light is detected by the LDR 326, which causes a high input voltage to the 555 timer 318 at pin 6 322 and a low output voltage from the 555 timer 318 at pin 3 324.

The 555 timer 318 is connected to a second 555 timer 328. The second 555 timer 328 is used to produce an astable circuit. The one or more lights 104 connected in series are connected to the second 555 timer 328 at pin 3 332. When light is not detected by the LDR 326, LDR resistance is high, causing a low input voltage to the 555 timer 318 at pin 6 322, a high output voltage from the 555 timer 318 at pin 3 324, a high input voltage to the second 555 timer 328 at pin 8 330, and a high output voltage from the second 555 timer 328 at pin 3 332 to the one or more lights 104. When light is detected by the LDR 326, LDR resistance is low, causing a high input voltage to the 555 timer 318 at pin 6 322, a low output voltage from the 555 timer 318 at pin 3 324, a low input voltage to the second 555 timer 328 at pin 8 330, and a low output voltage from the second 555 timer 328 at pin 3 332 to the one or more lights 104.

The 555 timer 328 may cause the one or more lights 104 to stay on for a period of time or flash repeatedly, dependent on values of a 47 ohm resistor 334, a 100 ohm resistor 336, and a 470 microfarad capacitor 338.

According to another embodiment of the present invention there is a method for turning off one or more lights. The method comprises connecting an electrical circuit and a metal stem for coupling with a conventional electrical threaded socket. The electrical circuit is on one or more circuit boards and may further include resistors, capacitors, diodes, and integrated circuits. The method comprises including one or more lights and a light sensitive component in the electrical circuit, such that the one or more lights turn off when light is detected by the light sensitive component. The light sensitive component may be an LDR. The method comprises housing the electrical circuit in a case and residing the light sensitive component on the case. The case is releasably attached to a cover. The method further comprises engaging/screwing the metal stem into a conventional 120 volt socket for electrical energy. The one or more lights may be multi-colored decorative lights or Christmas lights. As a result of the device, ordinary Christmas lights can be used with ordinary electrical light sockets, have automatic on/off functionality depending on light, that is low powered, long lasting, easy to install, inexpensive and portable.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description.

What is claimed is:

1. An electric light device comprising:
an electrical circuit including a light sensitive component, operably connected to one or more lights;
a metal stem for coupling with a conventional electrical threaded socket, the metal stem connecting to the electrical circuit; and
a case housing the electrical circuit, the light sensitive component residing on the case; wherein the one or more lights are off when light is detected by the light sensitive component.

2. The device according to claim 1, wherein the case is threaded and the cover is threaded at an end for coupling to the case.

3. The device according to claim 1, wherein the electrical circuit is operably connected to an on/off switch, the on/off switch being on the case; wherein the one or more lights are off when the on/off switch is set to an off position; and wherein the one or more lights are on when the on/off switch is set to an on position.

4. The device according to claim 3, wherein the electrical circuit connects to a music player;
and wherein the music player produces music when the on/off switch is set to an on position.

5. The device according to claim 1, wherein the electrical circuit is operably connected to a music player and a music on/off switch, the music on/off switch being on the case; wherein the music player produces music when the on/off switch is set to an on position.

6. The device according to claim 1, wherein the light sensitive component is a light dependent resistor.

7. The device according to claim 1, wherein the electrical circuit causes the one or more lights to flash.

8. The device according to claim 1, wherein the one or more lights are multi-colored or includes a standard light bulb.

9. The device according to claim 1, further comprising a cover encasing the one or more lights, the cover being releasably attachable to the case.

10. The device according to claim 1, wherein the electrical circuit comprises:
a connection across an alternating current input;
a 220 ohm resistor connected in series to the alternating current input;
a bridge rectifier connected to the 220 ohm resistor, wherein the bridge rectifier comprises of four IN4001 rectifier diodes;
a one microfarad capacitor and a 100,000 ohm resistor provided in parallel between the 220 ohm resistor and the bridge rectifier;
a 100 microfarad capacitor connected to the bridge rectifier;
a first 555 timer connected to the 100 microfarad capacitor;
a 12 volt zener diode (type IN4742A), wherein a zener diode cathode is connected to the first 555 timer at a first 555 timer pin 8 and wherein a zener diode anode is connected to a ground;
a light dependent resistor connected between the first 555 timer pin 8 and a first 555 timer pin 6;
a second 555 timer connected to the first 555 timer; and
one or more lights connected to the second 555 timer in series.

11. An electric light device comprising:
an electrical circuit including a light sensitive component and one or more lights, the one or more lights being attached to one or more surfaces;
a metal stem for coupling with a conventional electrical threaded socket, the metal stem connecting to the electrical circuit;
a case having one or more slots, the case housing the electrical circuit, the light sensitive component residing on the case, and the one or more surfaces connected to the case at the one or more slots; and
a cover encasing the one more lights, the cover being releasably attachable to the case;
wherein the one or more lights are off when light is detected by the light sensitive component.

12. The device according to claim 11, wherein the case is threaded and the cover is threaded at an end for coupling to the case.

13. The device according to claim 11, wherein the electrical circuit connects to an on/off switch, the on/off switch being on the case; wherein the one or more lights are off when the on/off switch is set to an off position; and wherein the one or more lights are on when the on/off switch is set to an on position.

14. The device according to claim 13, wherein the electrical circuit connects to a music player; and wherein the music player produces music when the on/off switch is set to an on position.

15. The device according to claim 11, wherein the electrical circuit connects to a music player and a music on/off switch, the music on/off switch being on the case; wherein the music player produces music when the on/off switch is set to an on position.

16. The device according to claim 11, wherein the light sensitive component is a light dependent resistor.

17. The device according to claim 11, wherein the electrical circuit causes the one or more lights to flash.

18. The device according to claim 11, wherein the one or more lights are multi-colored colored or includes a standard light bulb.

19. The device according to claim 11, wherein the electrical circuit comprises:
a connection across an alternating current input;
a 220 ohm resistor connected in series to the alternating current input;
a bridge rectifier connected to the 220 ohm resistor, wherein the bridge rectifier comprises of four 1N4001 rectifier diodes;
a one microfarad capacitor and a 100,000 ohm resistor provided in parallel between the 220 ohm resistor and the bridge rectifier;
a 100 microfarad capacitor connected to the bridge rectifier;
a first 555 timer connected to the 100 microfarad capacitor;
a 12 volt zener diode (type IN4742A), wherein a zener diode cathode is connected to the first 555 timer at a first 555 timer pin 8 and wherein a zener diode anode is connected to a ground;
a light dependent resistor connected between the first 555 timer pin 8 and a first 555 timer pin 6;
a second 555 timer connected to the first 555 timer; and
one or more lights connected to the second 555 timer in series.

20. An electric light device comprising:
an electrical circuit including a light sensitive component, the electrical circuit operable to connect to an existing conventional light bulb;
a metal stem for coupling with a conventional electrical threaded socket, the metal stem connecting to the electrical circuit; and
a case housing the electrical circuit, the light sensitive component residing on the case, and the case configured to operably receive the light bulb;
wherein when light is detected by the light sensitive component, electricity to the light bulb switches off.
